(19) United States
(12) Patent Application Publication
(10) Pub. No.: US 2026/0053699 A1
(43) Pub. Date: Feb. 26, 2026

(54) Massage gun with Handle Extension Function

(71) Applicant: Wayne Innovation (Xiamen) Technology Co., Ltd, Xiamen (CN)

(72) Inventors: Jinzhou WANG, Xiamen (CN); Yuemin LIU, Xiamen (CN); Huicheng ZHANG, Xiamen (CN)

(21) Appl. No.: 19/276,618

(22) Filed: Jul. 22, 2025

(30) Foreign Application Priority Data
Aug. 23, 2024 (CN) 2024220588706

(51) Int. Cl. A61H 23/02

(52) U.S. Cl. CPC A61H 23/0254; A61H 2201/0153; A61H 2201/1215

(57) ABSTRACT

Provided is a massage gun with a handle extension function. The device includes a handle portion and a massage portion, wherein the massage portion is internally provided with a transmission mechanism, and the handle portion is internally provided with a power source. The massage gun further includes at least one bendable extension portion, with both ends of the bendable extension portion respectively provided with a first connection structure and a second connection structure. One end of the massage portion is provided with the first connection structure. By incorporating the bendable extension portion, when it is necessary to massage any area of a user's back, the massage portion and the handle portion can be disassembled. One end of the bendable extension portion is then fixed to the massage portion, and the other end is fixed to the handle portion, thereby effectively extending the handle.

### CROSS-REFERENCE TO RELATED APPLICATIONS

This application claims a foreign priority to Chinese patent application No. 202422058870.6, filed on Aug. 23, 2024 in China National Intellectual Property Administration (CNIPA). The content of the aforementioned application, including any intervening amendments thereto, is incorporated herein by reference.

### TECHNICAL FIELD

The present disclosure relates to the technical field of massage guns, and more particularly to a massage gun with a handle extension function.

### BACKGROUND OF THE INVENTION

A massage gun primarily stimulates muscles, tendons, and various receptors within joint capsules through high-frequency vibrations. Using a massage gun to perform massage operations on the human body can help alleviate myogenic pain, increase pain threshold, reduce lactic acid buildup, and relieve soreness after exercise, thereby shortening the muscle recovery time.

Existing massage guns are typically designed with handles set at angles suitable for frontal gripping during massage. The massage head is generally perpendicular to the handle, which limits the massage range. As a result, when users attempt to massage various parts of the body, such as the back, the fixed handle position of current massage guns makes the operation inconvenient. Additionally, due to the limited range of motion of the human arm, it is difficult to perform effective and sustained massage on certain areas when operating the device alone.

### SUMMARY OF THE INVENTION

To overcome the shortcomings of the prior art, the present disclosure provides a massage gun with a handle extension function, aiming to solve the problems of existing massage guns having non-adjustable handles and being inconvenient for massaging different parts of the human body.

To address the above technical problems, the present disclosure provides the following technical solution: A massage gun with a handle extension function, including a handle portion and a massage portion. The massage portion is provided with a transmission mechanism, and the handle portion is provided with a power supply. The massage gun further includes at least one bending extension section. Both ends of the bending extension section are respectively provided with a first connection structure and a second connection structure. One end of the massage portion is provided with the first connection structure, and one end of the handle portion is provided with the second connection structure. The first and second connection structures are detachably and fixedly connected. The first connection structure is provided with a probe, and the second connection structure is provided with a conductive sheet. The probes on the first connection structures at both ends of the bending extension section and the conductive sheets on the second connection structures are connected via wires. When the first and second connection structures are fixedly connected, the probe and the conductive sheet form a contact-type electrical connection.

The power supply in the handle portion is electrically connected to the conductive sheet on the second connection structure via wires, and the transmission mechanism in the massage portion is electrically connected to the probe on the first connection structure via wires.

Preferably, the bending extension section is made of a deformable material.

Preferably, the second connection structure comprises a second cylinder, with one end of the second cylinder fixedly provided with a conductive sheet. The first connection structure comprises a first cylinder, one end of which has an opening sized to match the second cylinder. A plurality of probes are fixed circumferentially to the bottom surface of the inner wall of the opening. At least one positioning block is fixed to one side of the inner wall of the opening. A positioning groove is formed along the axial direction of the first cylinder on the side of the positioning block opposite to the side abutting the inner wall. A first sliding groove, not smaller than the positioning block in size, is formed along the axial direction on the outer edge of the second cylinder. A second sliding groove is formed along the axial direction on the outer edge of the end of the second cylinder opposite the conductive sheet. The second sliding groove communicates with the first sliding groove in an L-shape. A limiting member is disposed on the inner wall of the second sliding groove. When the second cylinder is inserted into the first cylinder and rotated relatively, the positioning block moves from the first sliding groove to the second sliding groove, and the limiting member moves into the positioning groove, causing the positioning block to abut against the inner wall of the second sliding groove.

Preferably, the limiting member is a spring-loaded detent ball and/or a rubber strip.

Preferably, the second connection structure comprises a second cylinder, one end of which is provided with an opening matching the size of the first cylinder. At least one first sliding groove is formed along the axial direction of the second cylinder on the inner wall of the opening. A second sliding groove is formed on one side wall of the first sliding groove along the circumferential direction of the second cylinder. The first connection structure comprises a first cylinder, with at least one limiting block disposed on its outer surface, sized not larger than the opening of the first sliding groove. The limiting block fits with the second sliding groove via interference.

Preferably, the limiting block is rectangular and/or L-shaped. When L-shaped, it comprises a horizontal portion and a vertical portion. A limiting member is fixedly installed on the bottom surface of the inner wall of the second sliding groove. The height of the vertical portion is greater than the height from the top of the limiting member to the top surface of the inner wall of the second sliding groove, and less than or equal to the height from the top to the bottom of the inner wall.

Preferably, the first connection structure comprises a first cylinder, and the second connection structure comprises a second cylinder. One end of the second cylinder is provided with an opening matching the size of the first cylinder. The inner wall of the opening is provided with internal threads. The outer surface of the first cylinder is provided with a mating structure, which may be external threads or a fixing block matching the internal threads.

Preferably, the first connection structure comprises a first cylinder. One end of the first cylinder is fixedly provided with a plurality of circumferentially distributed elastic tabs, each having a vertical section and a protruding section extending outwardly from the vertical section. The second connection structure comprises a second cylinder. One end of the second cylinder is formed with an opening matching the first cylinder, and the other end is provided with a fixing slot. Both ends of the fixing slot are inclined inwardly toward its center. The contact surfaces of the protruding sections and the outer edges of both ends of the fixing slot are formed as inclined or curved surfaces. The opening of the fixing slot is larger than or equal to the maximum distance between two vertical sections, and smaller than the maximum distance between two protruding sections.

Preferably, the outer wall of the first cylinder is provided with a circular groove. A sealing ring is disposed in the circular groove, and the diameter of the sealing ring is larger than that of the first cylinder.

Compared with the prior art, the beneficial effects of the present disclosure are as follows:

By providing a bending extension section, when it is necessary to massage any area of the back, the massage portion and handle portion can be disassembled, one end of the extension section can be connected to the massage portion, and the other end to the handle portion, thereby effectively extending the handle. This allows users to expand the massage range and area, avoiding the inconvenience or inaccessibility when massaging certain muscles in specific areas.

### BRIEF DESCRIPTION OF DRAWINGS

FIG. 1 is a schematic diagram of the overall structure of the present disclosure;

FIG. 2 is an exploded diagram corresponding to FIG. 1 of the present disclosure;

FIG. 3 is a schematic diagram showing the bending extension section, first connection structure, and second connection structure of the present disclosure;

FIG. 4 is a schematic diagram of the second connection structure and conductive sheet connection structure in Embodiment 1 of the present disclosure, wherein the limiting member is a spring-loaded detent ball;

FIG. 5 is a schematic diagram of the second connection structure and conductive sheet connection structure in Embodiment 1 of the present disclosure, wherein the limiting member is a rubber strip;

FIG. 6 is a schematic diagram of the second connection structure in Embodiment 1 of the present disclosure, wherein the two limiting members are respectively a rubber strip and a spring-loaded detent ball;

FIG. 7 is a schematic installation diagram of the first connection structure and the probe structure in Embodiment 1 of the present disclosure;

FIG. 8 is a top view corresponding to FIG. 7 of the present disclosure;

FIG. 9 is a schematic diagram of the first connection structure in Embodiment 2 of the present disclosure;

FIG. 10 is a schematic diagram of the second connection structure in Embodiment 2 of the present disclosure;

FIG. 11 is a schematic diagram showing the assembly structure of the first and second connection structures in Embodiment 3 of the present disclosure, wherein the mating structure is a fixing block;

FIG. 12 is a schematic diagram showing the assembly structure of the first and second connection structures in Embodiment 3 of the present disclosure, wherein the mating structure is an external thread;

FIG. 13 is a schematic diagram of the first connection structure in Embodiment 4 of the present disclosure;

FIG. 14 is a schematic diagram of the second connection structure in Embodiment 4 of the present disclosure;

FIG. 15 is a schematic diagram showing the assembly structure of the first and second connection structures in Embodiment 4 of the present disclosure;

In the figures: 1—Handle portion; 2—Massage portion; 3—Bending extension section; 4—First connection structure; 41—First cylinder; 42—Positioning block; 43—Positioning groove; 44—Abutment block; 45—Circular groove; 46—Limiting block; 461—Horizontal portion; 462—Vertical portion; 47—Scaling ring; 48—Elastic tab; 481—Vertical segment; 482—Protruding segment; 49—Mating structure; 5—Second connection structure; 51—Second cylinder; 52—First sliding groove; 53—Second sliding groove; 54—Limiting member; 55—Fixing slot; 56—Internal thread; 6—Conductive sheet; 7—Probe.

### DETAILED DESCRIPTION OF THE INVENTION

To facilitate a clearer understanding of the technical means, inventive features, objectives, and effects of the present disclosure, the following provides a more detailed description in conjunction with specific embodiments. It should be noted, however, that the embodiments described below are merely preferred examples and not exhaustive. Other embodiments that can be derived by those skilled in the art without inventive effort based on these embodiments are considered to fall within the scope of protection of the present disclosure.

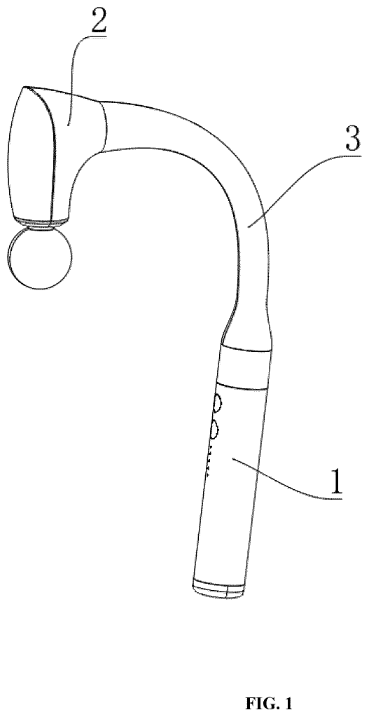

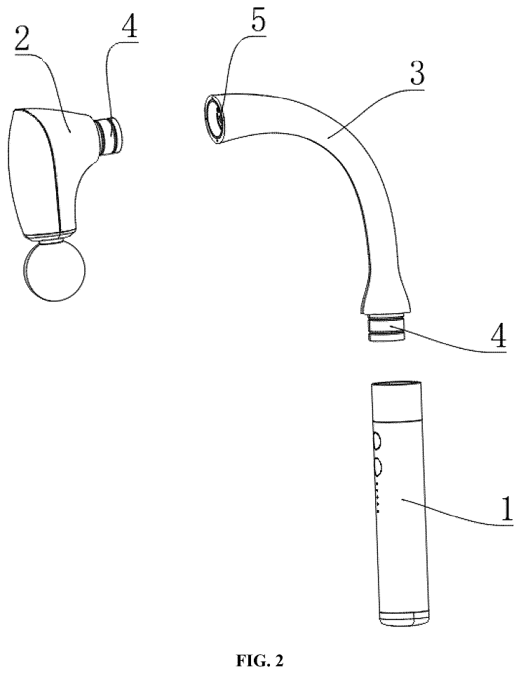

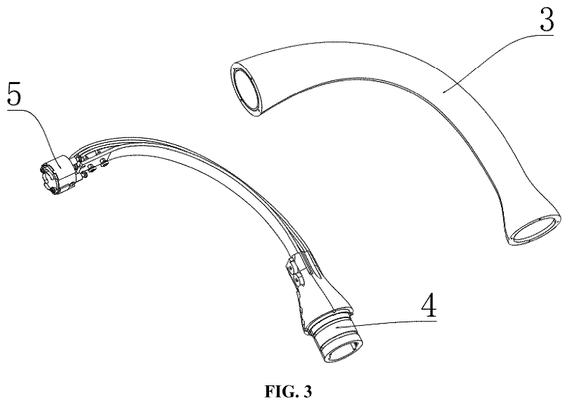

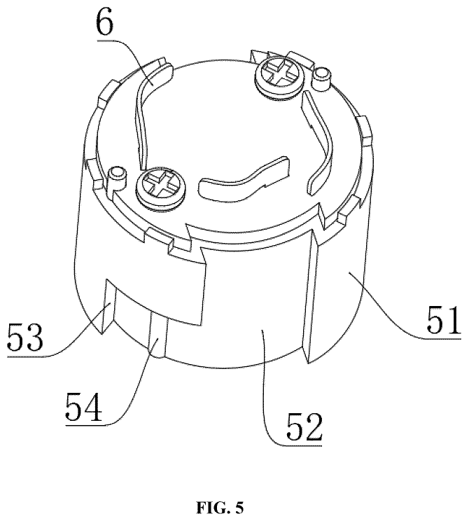

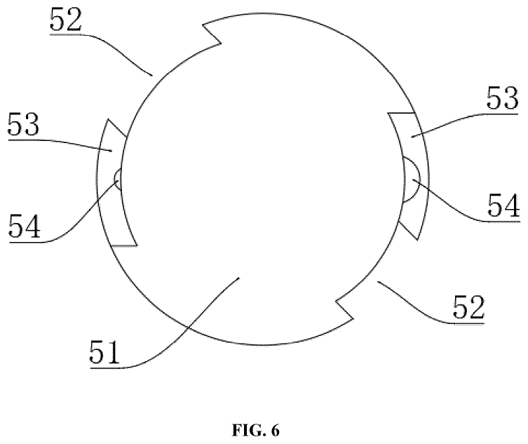

As shown in FIGS. 1 to 8, the present disclosure provides a massage gun with a handle extension function, comprising a handle portion 1 and a massage portion 2. A transmission mechanism is arranged inside the massage portion 2, which specifically includes a motor and a cam reciprocating mechanism. These components constitute a conventional structure of massage gun motion, and their operational principles will not be elaborated here. A power source is arranged inside the handle portion 1. The massage gun further includes at least one bending extension section 3, with both ends of the bending extension section 3 respectively provided with a first connection structure 4 and a second connection structure 5. One end of the massage portion 2 is provided with the first connection structure 4, and one end of the handle portion 1 is provided with the second connection structure 5. The first connection structure 4 and the second connection structure 5 are detachably and fixedly connected. The first connection structure 4 is provided with a probe 7, and the second connection structure 5 is provided with a conductive sheet 6. The probe 7 on the first connection structure 4 at both ends of the bending extension section 3 and the conductive sheet 6 on the second connection structure 5 are connected by wires. When the first connection structure 4 and the second connection structure 5 are fixedly connected, the probe 7 and the conductive sheet 6 are electrically connected via contact.

The power source inside the handle portion 1 is electrically connected to the conductive sheet 6 on the second connection structure 5 via wires. The transmission mechanism inside the massage portion 2 is electrically connected to the probe 7 on the first connection structure 4 via wires.

By designing the interface structure between the handle portion 1 and the bending extension section 3, the interface between the bending extension section 3 and the massage portion 2, and the interface between the handle portion 1 and the massage portion 2 to be identical, the handle portion 1 can be used either directly with the massage portion 2 or first combined with the bending extension section 3 and then assembled with the massage portion 2.

By providing the bending extension section 3, when it is necessary to massage any part of a person's back, the massage portion 2 and the handle portion 1 can first be separated. One end of the bending extension section 3 is then fixed to the massage portion 2, and the other end is fixed to the handle portion 1, thereby effectively extending the handle portion 1. This allows the user to expand the range and area of massage performed using the massage gun, avoiding inconvenience or inability to reach certain areas during massage of specific muscle regions.

Moreover, whether the massage gun is used with the bending extension section 3 assembled or the handle portion 1 is directly combined with the massage portion 2, the probe 7 and the conductive sheet 6 are in electrical contact when the first connection structure 4 and the second connection structure 5 are fixedly connected (i.e., at the interfaces between the handle portion 1 and the bending extension section 3, between the bending extension section 3 and the massage portion 2, and between the handle portion 1 and the massage portion 2). Since the power source inside the handle portion 1 is electrically connected via wires to the conductive sheet 6 on the second connection structure 5, and the transmission mechanism inside the massage portion 2 is electrically connected via wires to the probe 7 on the first connection structure 4, it ensures that the power source supplies power to the transmission mechanism in both connection configurations, thereby enabling consistent operation of the massage function.

As shown in FIGS. 1 to 3, the bending extension portion 3 is made of a deformable material, specifically rubber or soft metal materials such as gooseneck tubes. This enables a wider range of bending angle adjustments, further meeting the massage needs of different body parts and reducing discomfort caused by arm joint movements, thereby improving applicability.

The detachable fixed connection structure between the first connection structure 4 and the second connection structure 5 can be selected from the following options:

### Embodiment One

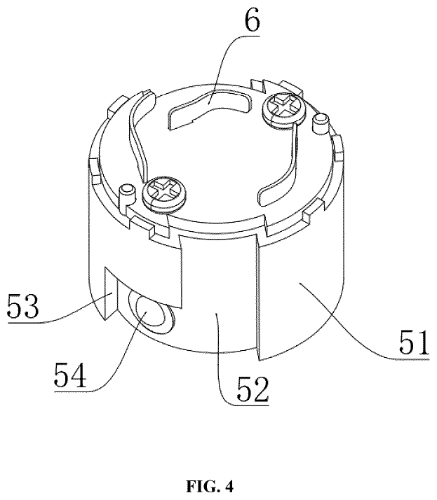

As shown in FIGS. 4 to 8, the second connection structure 5 includes a second cylinder 51, with one end fixedly attached to a conductive sheet 6, which can be a copper sheet. The first connection structure 4 includes a first cylinder 41, one end of which has an opening sized to fit the second cylinder 51. The inner wall at the bottom circumference of this opening is fixed with multiple probes 7. One side of the opening's inner wall is fixed with at least one positioning block 42. Opposite the side where the positioning block 42 contacts the inner wall, a positioning groove 43 is formed along the axis of the first cylinder 41.

The outer edge of the second cylinder 51 has a first sliding groove 52 along its axis, sized no smaller than the positioning block 42. Opposite the end where the conductive sheet 6 is fixed, the second cylinder 51 also has a second sliding groove 53 along the axis. The second sliding groove 53 communicates with the first sliding groove 52 in an L shape. The inner wall of the second sliding groove 53 is provided with a limiting member 54.

When the second cylinder 51 is inserted into the first cylinder 41 and rotated relative to it, the positioning block 42 moves from the first sliding groove 52 into the second sliding groove 53, and the limiting member 54 moves into the positioning groove 43. The positioning block 42 then fits snugly against the inner wall of the second sliding groove 53.

The limiting member 54 can be a spring positioning ball or/and a rubber strip.

Taking an example with two positioning blocks 42 and two limiting members 54, where one limiting member is a spring positioning ball and the other is a rubber strip:

To fix the first connection structure 4 and the second connection structure 5, align the end of the second cylinder 51 fixed with the conductive sheet 6 with the opening of the first cylinder 41, ensuring the positioning block 42 aligns with and enters the first sliding groove 52. Push in until the positioning block 42 aligns with the second sliding groove 53 and the probes 7 contact the conductive sheet 6. Then rotate the first or second cylinder in the forward direction to move the positioning block 42 into the second sliding groove 53.

When the limiting member 54 is a spring positioning ball, during the forward rotation, the positioning block 42 presses against the spring ball until the spring ball is positioned inside the positioning groove 43. This prevents relative rotation between the first cylinder 41 and second cylinder 51. Since the limiting member 54 moves into the positioning groove 43 and the positioning block 42 tightly fits against the inner wall of the second sliding groove 53, it also prevents relative axial movement between the cylinders, thereby fixing them firmly while maintaining electrical contact between the probes 7 and the conductive sheet 6.

When the limiting member 54 is a rubber strip, during forward rotation, the interference fit of the rubber strip prevents relative rotation between the first and second cylinders. As the rubber strip moves into the positioning groove 43, and the positioning block 42 fits against the second sliding groove inner wall, relative axial movement is also prevented. Thus, the connection between the first and second cylinders (and the connection structures) is fixed, maintaining probe-to-conductive sheet contact.

To detach the first connection structure 4 and second connection structure 5, reverse rotate the first or second cylinder with force, causing the limiting member 54 to disengage from the positioning groove 43 and the positioning block 42 to move out of the second sliding groove 53 back into the first sliding groove 52. Then pull the first and second cylinders apart until the positioning blocks 42 completely exit the first sliding grooves 52.

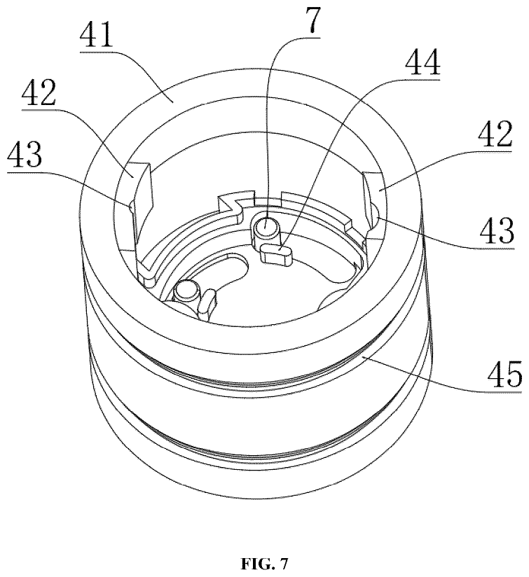

As shown in FIGS. 7 and 8, the opening's inner wall bottom circumference of the first cylinder 41 is equipped with multiple stops 44. The gap between the stops 44 and the probes 7 corresponds to the thickness of the conductive sheet 6, limiting and guiding its movement. This ensures that during rotation of the first or second cylinder, the conductive sheet 6 maintains contact with both the stops 44 and probes 7.

### Embodiment Two

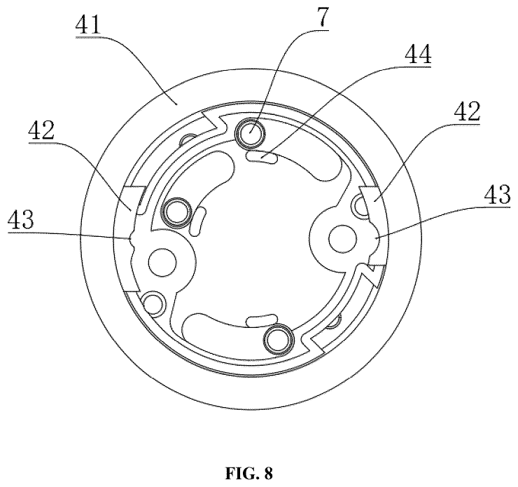

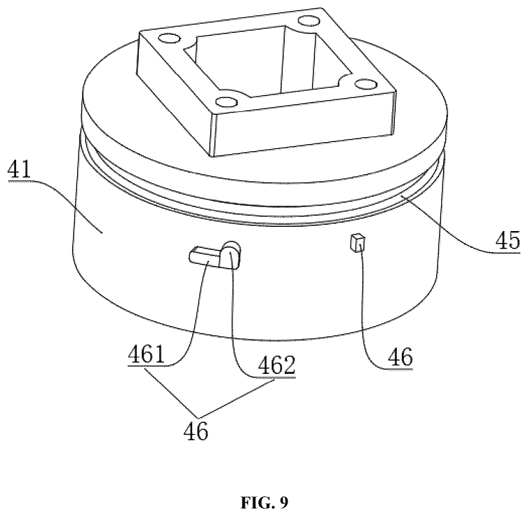

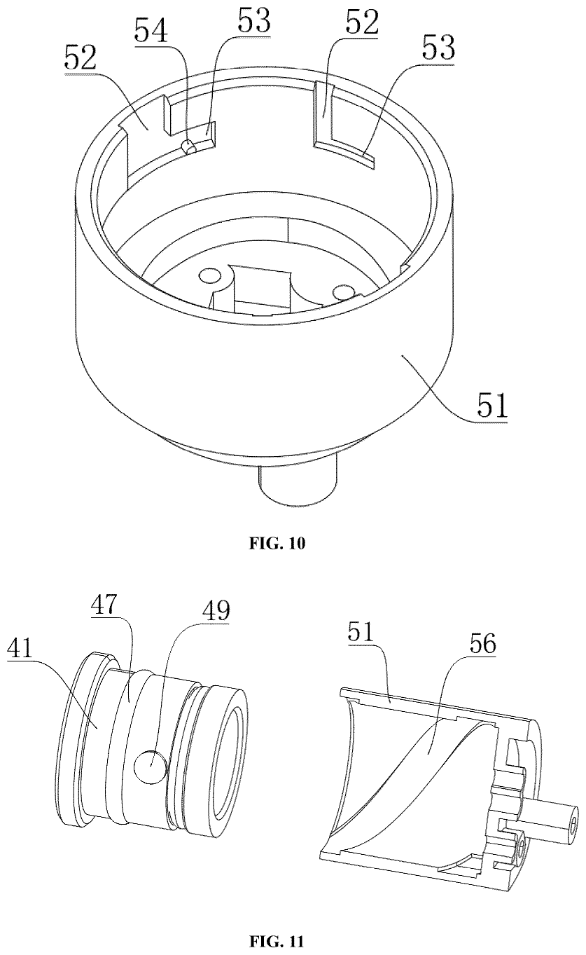

As shown in FIGS. 9 and 10, the second connection structure 5 includes a second cylindrical body 51, one end of which is provided with an opening dimensioned to mate with the first cylindrical body 41. A first sliding groove 52 is formed on the inner wall of the opening along the axial direction of the second cylindrical body 51, and a second sliding groove 53 is formed in the circumferential direction on one sidewall of the first sliding groove 52. The first connection structure 4 includes a first cylindrical body 41, and at least one limiting block 46 is disposed on the outer surface of the first cylindrical body 41, with a size not greater than the opening of the first sliding groove 52. The limiting block 46 is interference-fitted into the second sliding groove 53 and may be made of rubber material.

The limiting block 46 may be rectangular and/or L-shaped. When the limiting block 46 is L-shaped, it includes a horizontal portion 461 and a vertical portion 462. A limiting member 54 is fixedly mounted on the bottom inner wall of the second sliding groove 53. The height of the vertical portion 462 is greater than the distance from the top of the limiting member 54 to the inner top surface of the second sliding groove 53, and less than or equal to the height from the top surface to the bottom surface of the second sliding groove 53.

In this embodiment, four first sliding grooves 52, four second sliding grooves 53, and four limiting blocks 46 are provided. Among them, two limiting blocks 46 are rectangular, and the other two are L-shaped. Taking the example where the height of the vertical portion 462 equals the height of the second sliding groove 53 from top to bottom, the L-shaped limiting blocks 46 do not move vertically when positioned inside the second sliding grooves 53.

To secure the first connection structure 4 and the second connection structure 5, the first cylindrical body 41 is aligned with the opening of the second cylindrical body 51 such that the limiting blocks 46 align with and insert into the first sliding grooves 52. Then, the first cylindrical body 41 or the second cylindrical body 51 is rotated in the forward direction to cause the limiting blocks 46 to enter the second sliding grooves 53.

When the limiting blocks 46 are rectangular, an interference fit with the second sliding grooves 53 ensures that the first cylindrical body 41 remains stably positioned within the second cylindrical body 51, thereby completing the fixation of the first connection structure 4 and the second connection structure 5.

When the limiting blocks 46 are L-shaped, since the height of the vertical portion 462 is greater than the distance from the top of the limiting member 54 to the inner top surface of the second sliding groove 53 and equal to the height of the second sliding groove 53, the vertical portion 462 undergoes momentary interference fit while passing through the limiting member 54 and entering the innermost section of the second sliding groove 53. Due to the presence of the limiting member 54, the vertical portion 462 does not easily detach from the second sliding groove 53. Compared to rectangular limiting blocks 46, the rotational assembly of the first cylindrical body 41 and the second cylindrical body 51 is thus easier and less effortful. Furthermore, the distance between the limiting member 54 and the sidewall of the second sliding groove 53 may be set to the width of the vertical portion 462, enabling the vertical portion 462 to stably engage within the second sliding groove 53 without significant lateral movement.

Conversely, to disassemble the first connection structure 4 from the second connection structure 5, the first cylindrical body 41 or the second cylindrical body 51 is rotated in the reverse direction, causing the limiting blocks 46 to exit the second sliding grooves 53. Then, the first cylindrical body 41 and the second cylindrical body 51 are pulled apart in opposite directions until the limiting blocks 46 are completely removed from the first sliding grooves 52, thereby completing disassembly of the first connection structure 4 and the second connection structure 5.

### Embodiment Three

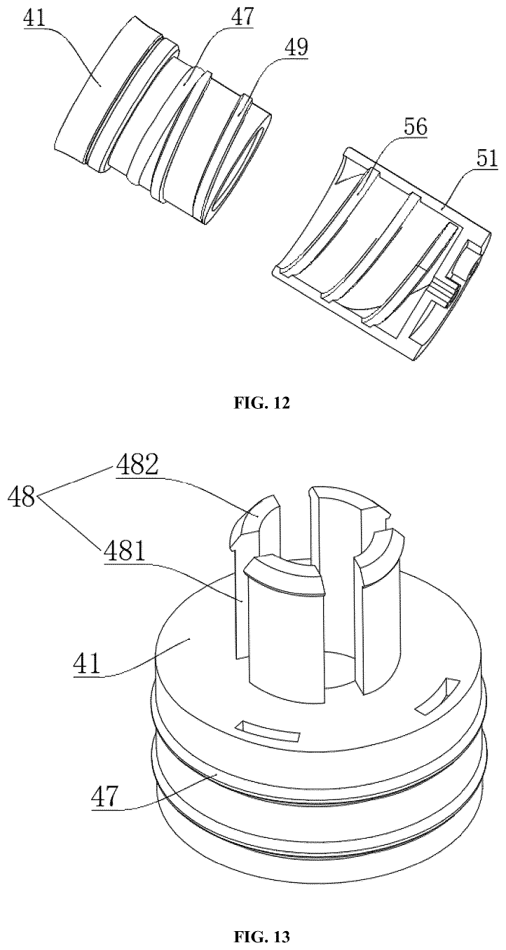

As shown in FIGS. 11 and 12, the first connection structure 4 includes a first cylindrical body 41, and the second connection structure 5 includes a second cylindrical body 51. One end of the second cylindrical body 51 is provided with an opening dimensioned to mate with the first cylindrical body 41. An internal thread 56 is formed on the inner wall of the opening, and a mating structure 49 is formed on the outer surface of the first cylindrical body 41. The mating structure 49 is configured as an external thread or a fixing block compatible with the internal thread 56.

To secure the first connection structure 4 and the second connection structure 5, the first cylindrical body 41 is aligned with the opening of the second cylindrical body 51 such that the external thread or fixing block aligns with the internal thread 56. The first cylindrical body 41 or the second cylindrical body 51 is then rotated in the forward direction to gradually thread the first cylindrical body 41 into the second cylindrical body 51, thereby completing the fixation of the first and second cylindrical bodies, and thus, the fixation of the first and second connection structures.

Conversely, to disassemble the first connection structure 4 from the second connection structure 5, the first cylindrical body 41 or the second cylindrical body 51 is rotated in the reverse direction to gradually unthread and separate the first cylindrical body 41 from the second cylindrical body 51.

### Embodiment Four

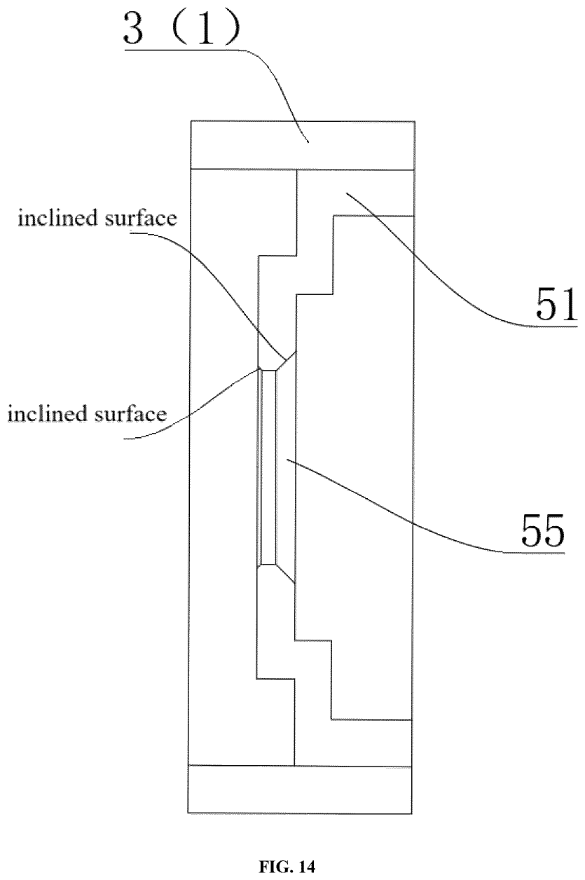

As shown in FIGS. 13, 14, and 15, the first connection structure 4 includes a first cylindrical body 41, with a plurality of circumferentially distributed elastic tabs 48 fixedly installed at one end. Each elastic tab 48 comprises a vertical section 481 and a protruding section 482 arranged around the outer periphery of the vertical section 481. The second connection structure 5 includes a second cylindrical body 51, which has an opening at one end adapted to fit the first cylindrical body 41, and a fixing groove 55 at the other end. Both edges of the fixing groove 55 opening are inclined inward toward the center, forming inclined surfaces. The contact surfaces between the protruding section 482 and the edges of the fixing groove 55 are also inclined or curved surfaces. The opening size of the fixing groove 55 is greater than or equal to the maximum distance between the two vertical sections 481 and less than the maximum distance between the two protruding sections 482.

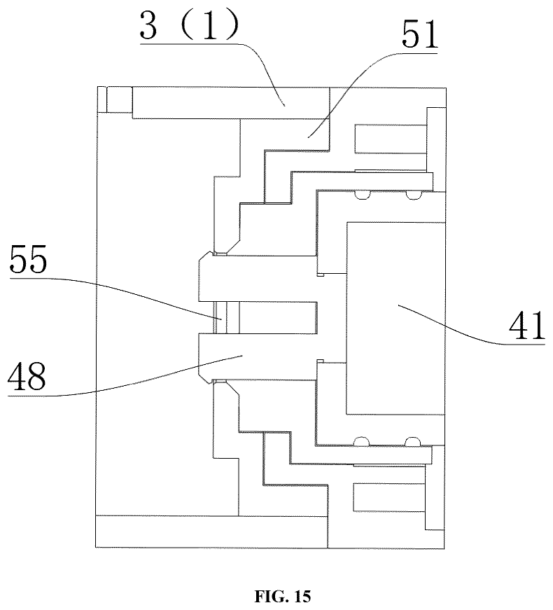

To secure the first connection structure 4 and the second connection structure 5, the first cylindrical body 41 is inserted into the opening of the second cylindrical body 51 until the protruding section 482 of the elastic tab 48 abuts one edge of the fixing groove 55 opening. Due to the inclined surface contact, the elastic tab 48 tilts inward toward the center of the first cylindrical body 41 until the protruding section 482 contacts the opposite edge of the fixing groove 55 opening, at which point the elastic tab 48 resets, and the first cylindrical body 41 is stably held within the opening of the second cylindrical body 51 (as shown in FIG. 15), thereby completing the fixation of the first and second connection structures.

To disassemble the first connection structure 4 and the second connection structure 5, a pulling force is applied to separate the two structures in opposite directions. Because the protruding section 482 contacts the fixing groove 55 edges via inclined or curved surfaces, the protruding section 482 gradually disengages from the fixing groove 55 while the clastic tab 48 tilts inward and then resets during this process, thus achieving a quick separation of the first and second cylindrical bodies, i.e., a quick disassembly of the first and second connection structures.

As shown in FIGS. 7, 9, 11, 12, and 13, a circumferential groove 45 is formed on the outer surface of the first cylindrical body 41, in which a sealing ring 47 is installed. The diameter of the sealing ring 47 is larger than the diameter of the first cylindrical body 41.

When the first cylindrical body 41 is inserted into and fixed within the second cylindrical body 51, the sealing ring 47 provides an interference fit, thereby stabilizing the fixation of the first cylindrical body 41 within the second cylindrical body 51.

Although the embodiments of the present disclosure have been shown and described, it should be understood by those skilled in the art that various modifications, substitutions, changes, and variations can be made without departing from the principles and spirit of the present disclosure. The scope of the disclosure is defined by the appended claims and their equivalents.

1. A massage gun with a handle extension function, comprising a handle portion (1) and a massage portion (2), the handle portion (1) being internally provided with a power source, wherein:
the massage portion (2) is internally provided with a transmission mechanism;
the massage gun further comprises at least one bendable extension portion (3), with both ends of the bendable extension portion (3) respectively provided with a first connection structure (4) and a second connection structure (5);
one end of the massage portion (2) is provided with the first connection structure (4), and one end of the handle portion (1) is provided with the second connection structure (5);
the first connection structure (4) and the second connection structure (5) are detachably and fixedly connected;
the first connection structure (4) is provided with a probe (7), and the second connection structure (5) is provided with a conductive sheet (6);
the probe (7) on the first connection structure (4) and the conductive sheet (6) on the second connection structure (5) at both ends of the bendable extension portion (3) are connected by wires;
when the first connection structure (4) and the second connection structure (5) are fixedly connected, the probe (7) and the conductive sheet (6) form a contact-based electrical connection;
the power source within the handle portion (1) is electrically connected to the conductive sheet (6) on the second connection structure (5) via wires, and the transmission mechanism in the massage portion (2) is electrically connected to the probe (7) on the first connection structure (4) via wires.

2. The massage gun with a handle extension function according to claim 1, wherein the bendable extension portion (3) is made of a deformable material.

3. The massage gun with a handle extension function according to claim 1, wherein the second connection structure (5) comprises a second cylindrical body (51), one end of which is fixed with the conductive sheet (6); the first connection structure (4) comprises a first cylindrical body (41), one end of which has an opening adapted to the size of the second cylindrical body (51); a plurality of probes (7) are fixed circumferentially on the bottom inner wall of the opening; at least one positioning block (42) is fixed on one side of the opening's inner wall; a positioning groove (43) is formed along the axial direction of the first cylindrical body (41) on the side of the positioning block (42) opposite the inner wall; a first sliding groove (52), no smaller than the positioning block (42), is formed on the outer edge of the second cylindrical body (51) along its axial direction; a second sliding groove (53) is formed on the outer edge of the end face of the second cylindrical body (51) opposite the conductive sheet (6), also along its axial direction; the second sliding groove (53) is in L-shaped communication with the first sliding groove (52); a limiting member (54) is provided on the inner wall of the second sliding groove (53);
after the second cylindrical body (51) is inserted into the first cylindrical body (41) and rotated, when the positioning block (42) moves from the first sliding groove (52) into the second sliding groove (53), the limiting member (54) enters the positioning groove (43), and the positioning block (42) fits tightly against the inner wall of the second sliding groove (53).

4. The massage gun with a handle extension function according to claim 3, wherein the limiting member (54) comprises a spring-loaded detent ball and/or a rubber strip.

5. The massage gun with a handle extension function according to claim 1, wherein the second connection structure (5) comprises a second cylindrical body (51) with one end having an opening adapted to the size of the first cylindrical body (41); at least one first sliding groove (52) is formed on the inner wall of the opening along the axial direction of the second cylindrical body (51); a second sliding groove (53) is formed on one side wall of the first sliding groove (52) in the circumferential direction of the second cylindrical body (51);
the first connection structure (4) comprises a first cylindrical body (41), and at least one limiting block (46) is disposed on the outer surface of the first cylindrical body (41) with a size not greater than the opening of the first sliding groove (52); the limiting block (46) is interference-fitted into the second sliding groove (53).

6. The massage gun with a handle extension function according to claim 5, wherein the limiting block (46) is rectangular and/or L-shaped; when the limiting block (46) is L-shaped, it comprises a horizontal portion (461) and a vertical portion (462); a limiting member (54) is fixedly mounted on the bottom inner wall of the second sliding groove (53);
the height of the vertical portion (462) is greater than the distance from the top of the limiting member (54) to the inner top surface of the second sliding groove (53) and less than or equal to the height from the top to the bottom inner surface of the second sliding groove (53).

7. The massage gun with a handle extension function according to claim 1, wherein the first connection structure (4) comprises a first cylindrical body (41), and the second connection structure (5) comprises a second cylindrical body (51); one end of the second cylindrical body (51) is provided with an opening adapted to the size of the first cylindrical body (41);
an internal thread (56) is formed on the inner wall of the opening, and a mating structure (49) is formed on the outer surface of the first cylindrical body (41); the mating structure (49) is an external thread or a fixing block adapted to the internal thread (56).

8. The massage gun with a handle extension function according to claim 1, wherein the first connection structure (4) comprises a first cylindrical body (41), one end of which is fixedly provided with a plurality of circumferentially distributed elastic tabs (48); each elastic tab (48) includes a vertical section (481) and a protruding section (482) disposed around the periphery of the vertical section (481);
the second connection structure (5) comprises a second cylindrical body (51), one end of which is provided with an opening adapted to the first cylindrical body (41), and the other end is provided with a fixing groove (55); both ends of the opening edge of the fixing groove (55) are inclined inward toward the center; the contact surfaces between the protruding sections (482) and the edges of the fixing groove (55) are formed as inclined or curved surfaces;
the opening size of the fixing groove (55) is greater than or equal to the maximum distance between two vertical sections (481) and less than the maximum distance between two protruding sections (482).

9. The massage gun with a handle extension function according to claim 8, wherein a circular groove (45) is formed on the outer wall of the first cylindrical body (41); a sealing ring (47) is disposed in the circular groove (45); the diameter of the sealing ring (47) is greater than the diameter of the first cylindrical body (41).
